(19) United States
(12) Patent Application Publication
(10) Pub. No.: US 2020/0099249 A1
(43) Pub. Date: Mar. 26, 2020

(54) OPTIMIZED STRUCTURE OF A DC VOLTAGE SYSTEM AND METHOD IN THE EVENT OF FAILURE OF THE SUPPLYING NETWORK

(71) Applicant: SIEMENS AKTIENGESELLSCHAFT, 80333 München (DE)

(72) Inventors: Hubert Schierling, Erlangen (DE); BENNO WEIS, Hemhofen (DE)

(73) Assignee: SIEMENS AKTIENGESELLSCHAFT, 80333 München (DE)

(21) Appl. No.: 16/495,951

(22) PCT Filed: Mar. 20, 2018
(86) PCT No.: PCT/EP2018/056934

§ 371 Date: Sep. 20, 2019

(30) Foreign Application Priority Data
Mar. 23, 2017 (EP) 17162620.3

(51) Int. Cl. H02J 9/06; H02J 5/00; H02M 7/219; H02H 7/125

(52) U.S. Cl. CPC H02J 9/06; H02J 5/00; H02J 2300/22; H02H 7/1252; H02M 7/219

(57) ABSTRACT

The invention relates to an electrical DC voltage system which is coupled to at least one AC voltage network (1). A supply circuit (5) is used to convert three-phase AC voltage into DC voltage which supplies a DC voltage system. The latter contains devices (13, 14, 21, 23, 27, 22, 17, 19, 20) each having a decentralized precharge device (7). The invention also relates to a method for operating such an electrical DC voltage system on the basis of a voltage value applied to the busbar (12).

The invention relates to a method for operating an electrical DC voltage system which is linked by means of a supply circuit to at least one AC voltage network for supplying electrical energy to the DC voltage system.

The invention further relates to an electrical DC voltage system for carrying out a method for operating an electrical DC voltage system which is linked to at least one AC voltage network for supplying electrical energy to the DC voltage system.

Distribution of electrical energy on a DC basis is frequently used within industrial plant, as it enables energy to be easily exchanged between different items of equipment and allows storage devices and regenerative energy sources to be conveniently interconnected.

For this purpose a DC voltage system is typically connected by means of a passive diode rectifier to an existing three-phase network from which the required electrical energy is drawn. It is also possible for an active rectifier to be used which accomplishes the suppling of electrical energy by means of IGBTs (short for insulated-gate bipolar transistor; bipolar transistor with insulated gate electrode).

In both supply variants, the value of the DC voltage must not be significantly lower than the value of the rectified three-phase AC voltage. This is because excessively large differences between the two voltages will attempt to even themselves out. An uncontrollable current which attempts to equalize the value of the DC voltage in the DC voltage system to the value of the rectified three-phase AC voltage would flow and risk damaging components, particularly power semiconductors.

A circulating current of this kind must be limited, particularly at startup of an uncharged DC voltage system connected to a three-phase AC voltage network.

DE 19739553 A1 therefore discloses a pre-charging circuit for a capacitor connected at the output of a line-commutated converter, wherein the converter is designed as an uncontrolled rectifier.

In addition, EP 2680421A1 deals with a frequency converter for operating an electrical machine on an electrical network. The frequency converter has an supply unit, a converter and a DC link connecting the supply unit to the converter. At least one DC link capacitor is provided in the DC link. EP 2680421 A1 also relates to a method for charging the DC link capacitor, which is termed precharging.

Patent specification US 20080100136 A1 relates to a system and a power supply method on board an aircraft. The power supply system of an aircraft consists of a plurality of generators which supply a plurality of different electrical cores with 230 volts AC, wherein the different loads of the aircraft are connected to each of these cores

Patent specification EP 2503666 A2 discloses a power supply system for an electric drive of a naval vessel. The electric drive has a first operating state in which electrical energy is supplied from the power source to the electric drive in order to operate the electric drive, and a second operating state in which the electric motor of the electric drive is decelerated or braked, wherein the electric drive generates electrical energy in the second operating state. The power supply system comprises an electrical energy store device for storing the electrical energy generated.

Patent application US 20080174177 A1 relates to a system and a method for powering an aircraft having a plurality of generators which deliver alternating current to a plurality of different primary electrical master boxes, wherein the different aircraft loads are connected to each of these master boxes. This system comprises conventional master boxes which supply current loads, and at least one master box which is designed for actuator loads, wherein at least one master box present is connected to the conventional master boxes.

In patent application EP 2757647 A2, a PMAD (Power Management and Distribution) system comprises a first power supply unit of a first type, a second power supply unit of a second type which is different from the first type, and a first and second load. The PMAD system comprises an array of solid state power controllers (SSPCs) which are connected between the first and second power supply and the first and second load. The array is configured such that it selectively supplies each first and second load with a large number of different power levels, based on the input/output states of the SSPCs in the array.

Patent application EP 2562900 A2 discloses the following: an electrical power supply system comprises an electrical power generating system (EPGS); one or more constant loads which are supplied by the EPGS; and a power management and distribution (PMAD) center which is located between the EPGS and the one or more constant loads, wherein the PMAD center comprises a plurality of load management channels, wherein each of the load management channels corresponds to a respective constant load, wherein each of the load management channels comprises a load management function and an isolating filter.

Patent application US 20070159007 A1 shows a battery charge leveling system for an electrically operated system in which a battery is subject to intermittent high-current loading, wherein the system comprises a first battery, a second battery and a load connected to the batteries. The system comprises a passive storage device, a unidirectional conducting device which is connected in series with the passive storage device and is polarized so as to conduct the current from the passive storage device to the load, the electrical series circuit which is connected in parallel with the battery so that the passive storage device supplies current to the load when the battery terminal voltage is less than the voltage present at the passive storage device, and a battery switching circuit which connects the first and the second battery either in a lower-voltage parallel arrangement or in a higher-voltage serial arrangement.

When the supplying three-phase AC voltage network cannot cover the power consumption of the connected DC voltage system or even fails, this causes a reduction in the voltage value in the DC voltage system, The power shortfall for the loads in the DC voltage system is initially covered by capacitances present in the DC voltage system. Long outages cannot be bridged in this way.

Further problems also arise: when a switch in the pre-charging circuit remains closed when the DC voltage reduces, on restoration of the three-phase AC voltage an uncontrollable, rapidly increasing and high re-charging current is produced which will damage or even destroy sensitive components.

When the switch in the pre-charging circuit is opened when the DC voltage reduces, a re-charging current is limited to a pre-charging current. However, this current is not sufficient to provide the electrical energy required for the continued operation of the DC network. The DC voltage in the DC voltage system therefore reduces further and the equipment eventually has to be shut down.

The object of the invention is to bridge failures of a supplying three-phase AC voltage network for a sufficient length of time without risking damage to sensitive components when the three-phase AC voltage network is restored.

This object is achieved by a method for operating an electrical DC voltage system which is linked by means of a supply circuit to at least one AC voltage network for supplying electrical energy to the DC voltage system, wherein the electrical DC voltage system comprising items of equipment each connected via at least one local pre-charging device to a busbar is operated as a function of a voltage value present on the busbar, wherein
when the voltage value is greater than a minimum voltage Umin1, the electrical DC voltage system is operated in normal mode in which the supply circuit (5) is connected to the AC voltage network and the local pre-charging device (7) is deactivated, and
when the voltage value falls below the minimum voltage Umin1, the supply circuit (5) is disconnected from the AC line supply (1).

In the following, this voltage value will also be termed the “DC voltage in the DC voltage system” or “DC voltage”.

The object is also achieved by an electrical DC voltage system for carrying out a method for operating an electrical DC voltage system which is linked to at least one AC voltage network for supplying electrical energy to the DC voltage system, wherein a plurality of items of equipment present in the DC voltage system are each connected to a busbar via at least one local pre-charging device.

The advantage of the invention is that the items of equipment present in an electrical DC voltage system have at least one local pre-charging device. This optimized structure of a DC voltage system allows improved startup of an uncharged DC network, safe behavior during failure of a supplying three-phase AC voltage network as well as long-term bridging of an outage. In addition, differences between the DC voltage in the DC network and a value of a rectified three-phase AC voltage are avoided, which means that no currents flow which could damage sensitive components.

The electrical DC voltage system is connected to the AC voltage network via a supply circuit. The AC voltage network is preferably implemented as a three-phase AC voltage network.

According to an advantageous embodiment, the supply circuit comprises a switch for each phase so that the supply circuit can be disconnected from the three-phase AC voltage network, a choke for each phase, and a rectifier. Passive components, particularly diodes, or controllable semiconductors, particularly IGBTs, are preferably used in the rectifier to convert the three-phase AC voltage into a DC voltage.

The supply circuit also incorporates a smoothing capacitor. The capacitor has only a small capacitance so that a charging current caused by connection of the electrical DC voltage system to the three-phase AC voltage network does not damage the components present in the DC voltage system. Alternatively, the supply circuit can also contain a pre-charging device which, however, only needs to be designed for pre-charging of the supply-circuit capacitor itself.

The supply circuit supplies a busbar in the DC voltage system via a switching and protection device. At least two items of equipment are inventively connected to said busbar via a respective local switching and protection device with pre-charging resistor, hereinafter also referred to as a local pre-charging device for short.

Item of equipment within the context of the invention is to be understood as meaning a single piece of equipment, a combination of a plurality of pieces of equipment and/or a sub-system.

Possible pieces of equipment are electrical loads, particularly fans, motors, robots, pumps, heaters and inverters, or energy storage units or energy stores, particularly capacitive storage units and batteries, or energy sources, particularly photovoltaic systems.

According to the invention, said items of equipment are not only assigned switching and protection devices, but in each case a pre-charging device.

A single local pre-charging device is advantageously used for each item of equipment. This comprises at least one resistor which is arranged in parallel with preferably two anti-series connected controllable semiconductors with anti-parallel freewheeling diode, wherein this circuit arrangement is arranged in series with at least one switch.

Alternatively, the switch can also be arranged in series with the resistor instead of in series with the entire circuit arrangement. The advantage of this solution is that the load current does not flow through the switch when the controllable semiconductor is conducting.

The local pre-charging device can be incorporated in the respective item of equipment or connected upstream of the respective item of equipment.

When the switch is closed and at least one controllable semiconductor is non-conducting, the current flows via the resistor, When the switch is in the closed state and at least the controllable semiconductor required for bridging the resistor is conducting, the current does not flow through the resistor, but through the conducting controllable semiconductor and the freewheeling diode of the other controllable semiconductor with antiparallel freewheeling diode disposed in the local pre-charging device. When the switch is opened, no current flows, as there is no closed circuit. Bipolar transistors, particularly IGBTs, or field-effect transistors, particularly MOSFETs, are advantageously used as semiconductors.

Using a local pre-charging device is advantageous in that it obviates the need to provide a pre-charging unit integrated in the supply circuit that requires precise knowledge of the total capacitance of the DC voltage system and which has to be designed for pre-charging of the total capacitance.

In addition, a DC voltage system equipped with local pre-charging devices can be easily augmented by further system sections, as the local pre-charging devices need only be designed for their downstream sub-systems and/or items of equipment.

All the energy storage devices and/or sources present can be advantageously used for continued operation of the DC voltage system. This ensures an orderly ramp-down or shutdown of items of equipment, particularly robots or motors.

When the switches present in the supply circuit cause the DC voltage system to be connected to the three-phase AC voltage network, the supply circuit itself is initially pre-charged. For this purpose the switches in all the local pre-charging devices are open. When the supply circuit is pre-charged and any pre-charging resistor present there is bridged, the DC voltage in the DC voltage system amounts to the value of the rectified voltage of the three-phase AC voltage network. Subsequently all the local pre-charging devices in the DC voltage system are preferably activated. The switch preferably of each local pre-charging device is dosed and a control unit turns off the IGBTs so that a charging current flows via the resistor, thereby charging the capacitors in the DC voltage system.

As soon as the difference between the DC voltage present in the DC voltage system and the DC voltage of an item of equipment falls below a value, the pre-charging process for said item of equipment is terminated and the local pre-charging device is deactivated by an IGBT being rendered conducting in each case. The minimal voltage difference ensures that only a small circulating current flows which does not have any component damaging effect. An active supply circuit, in particular comprising IGBTs, according to the prior art, or a passive supply circuit, in particular comprising diodes, according to the prior art, supplies electrical energy to the DC voltage system. The pre-charging process for the DC voltage system is terminated when all the local pre-charging devices are deactivated.

The DC voltage and/or the three-phase AC line voltage are monitored by a supervision unit which is implemented as part of the supply circuit and/or advantageously in each local pre-charging device. When a supervision unit for voltage measurement is incorporated in each local pre-charging device, no error-prone and costly communication solution between the individual pre-charging devices and a higher-order supervision unit is necessary.

Advantageously, when a supply circuit is active, the DC voltage in the DC voltage system is preferably adjusted by a control unit to a value which corresponds at least to the peak value of the network voltage at an upper tolerance limit.

According to the invention, the DC voltage system responds with defined action to different states of a voltage, as will be explained below.

When the DC voltage is above a minimum value Umin1 or is equal to Umin1, DC voltage system and associated items of equipment are operated in normal mode. The DC voltage system is connected to the three-phase AC voltage network by means of a supply circuit, the local pre-charging devices are deactivated.

In response to failure of the supplying three-phase AC voltage network or reduction of the DC voltage to below a minimum value Umin1 being detected in particular by a supervision unit, the following action is basically taken by a control unit: the supply circuit is disconnected from the three-phase AC voltage network. In addition, a DC voltage setpoint value is preferably increased to a peak value of the AC voltage at an upper tolerance limit. As a result, controllable energy storage devices and/or sources present in the DC voltage system are caused by a control unit to supply electrical power to the DC system.

In addition, less critical loads, particularly fans and/or pumps and/or heaters, are advantageously shut down or limited by the control unit in order to reduce the power consumption. When the DC voltage value increases as a result of shutting down less critical loads or of at least one additional power supply from an energy source, particularly from a photovoltaic system, and exceeds the value Umin1, the DC voltage system is operated normally and the supply circuit is connected. As the value of the DC voltage of the DC voltage system is greater than Umin1, the re-charging current is limited to a non-critical value.

“Exceed” means that the value changes from a value below the minimum value (here Umin1) to a value above the minimum value.

Conversely, “fall below” means that the value changes from a value above the minimum value to a value below the minimum value.

The action is preferably taken immediately after the minimum value is exceeded or fallen below. However, it is also possible for the respective action to be delayed by a particular waiting time.

However, when the total power consumed by the loads in the DC system continues to be greater than the total power provided by controllable energy storage devices and/or sources, the DC voltage in the DC voltage system continues to decrease.

When the DC voltage decreases further and falls below a minimum value Umin2, the local pre-charging devices are activated—preferably by means of at least one control unit. The supplying of electrical energy by energy storage devices present in the DC voltage system, particularly capacitive storage devices, and/or energy sources, particularly photovoltaic systems, is interrupted. All the loads present in the DC voltage system are disconnected.

A minimum value Umin3 being fallen below can be used as a signal that all the local pre-charging devices are activated. This signal is a prerequisite for the supply being able to be resumed when the 3-phase AC voltage network is restored. The DC voltage system is on standby and awaits restoration of the three-phase AC voltage network.

When the three-phase AC voltage network is restored, the pre-charging process recommences, as already described for connection of the DC voltage system. No high, rapidly increasing charging current arises, which means that sensitive components are in no risk of damage.

In an alternative embodiment, when a DC voltage in the DC voltage system falls below a minimum value Umin2, the DC voltage setpoint for controllable energy storage devices and/or sources in the DC voltage system is increased to a peak value of the network voltage at an upper tolerance limit. Loads and/or other items of equipment in the DC voltage system are disconnected. By supplying electrical energy, the energy storage devices and sources increase the DC voltage so that the value Umin2 is exceeded. Items of equipment, particularly motors or robots, are connected, causing them to be able to move to a defined position or complete at least some of this movement before consumption of electrical energy causes the DC voltage in the DC voltage system to fall below the value Umin2 again. The energy storage devices and sources increase the DC voltage once more by supplying electrical energy so that, when the value Umin2 is exceeded, robots or motors can complete the remainder of their movement to a defined position. A cyclical sequence of this kind ensures a safe system, as a network failure does not produce any undefined states for robots or motors. In addition, long outage times of the supplying three-phase AC voltage network can be bridged.

In the method described hitherto, the state may arise that the controllable energy storage devices and/or sources continuously maintain the DC voltage between the values Umin1 and Umin2. When the three-phase AC voltage network is restored during this state, it cannot supply energy, as the supply circuit is disconnected from the three-phase AC voltage network. When power restoration is detected, in an embodiment according to the invention a higher-order control unit turns off loads that are less critical. As a result, the DC voltage increases above the value Umin1 so that the switches which disconnect the supply circuit from the three-phase AC voltage network can be closed in order to supply energy to the DC voltage system. The previously shut down, less critical loads are connected. This method allows no-break operation of sensitive loads.

The invention will now be described and explained in greater detail with reference to the exemplary embodiments depicted in the accompanying drawings in which:

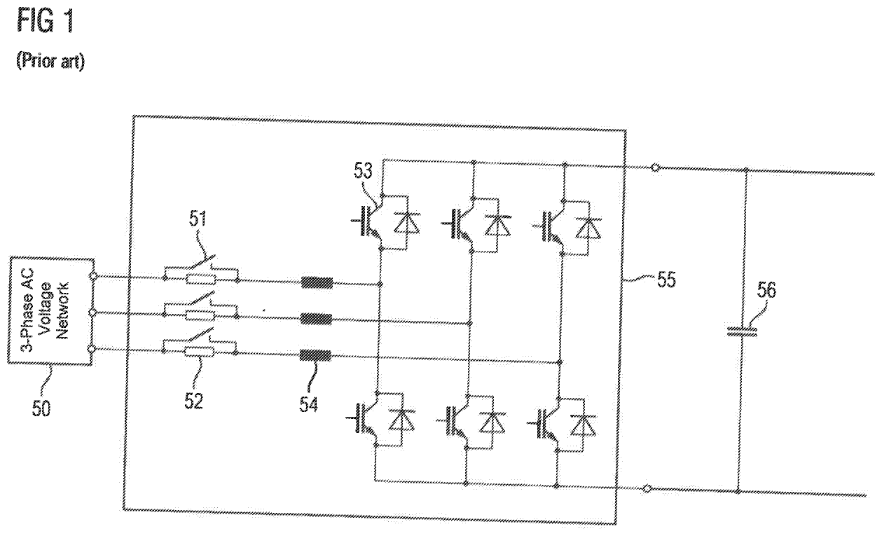

FIG. 1 shows an active supply circuit with pre-charging device according to the prior art,

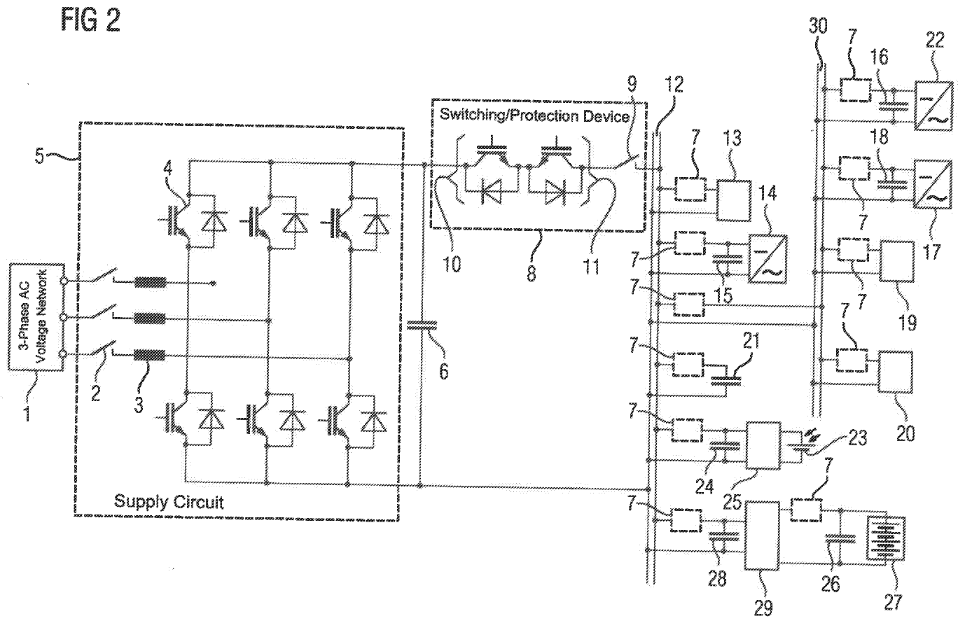

FIG. 2 shows an embodiment of a DC voltage system with local pre-charging devices which is connected to a three-phase AC voltage network via a supply circuit,

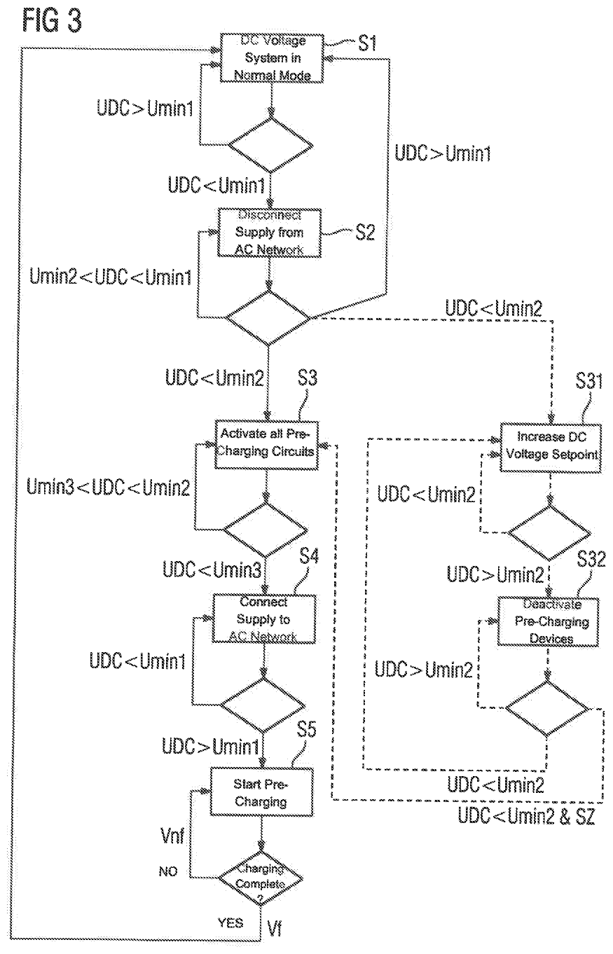

FIG. 3 shows a method for operating an electrical DC voltage system, and

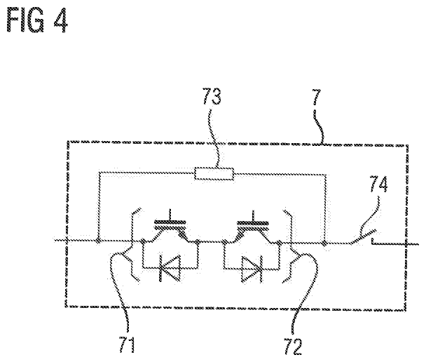

FIG. 4 shows an embodiment of a switching and protection device with pre-charging resistor.

FIG. 1 shows an embodiment of an active supply circuit with pre-charging device 55, also termed supply circuit, according to the prior art. A DC voltage system is linked to a three-phase AC voltage network 50 via a supply circuit 55. For each phase, the supply circuit 55 has a switch 51 which can bridge a pre-charging resistor 52 for each phase.

The supply circuit also has chokes 54 which are required for storing energy for increasing the DC voltage. Rectification of a three-phase AC voltage from the three-phase AC voltage network 50 is performed by means of controllable semiconductors 53, particularly IGBTs. However, it is also possible for passive components, particularly diodes, to be used for rectifying a three-phase AC voltage. The supply circuit also incorporates a smoothing capacitor 56. When the DC voltage system is uncharged, current limiting must be ensured when the three-phase AC voltage network 50 is switched on, as any voltage difference between a DC voltage in the DC voltage system and a rectified AC voltage results in an uncontrollable current which damages or destroys sensitive components in the DC voltage system. This current limiting is achieved by the pre-charging device in the supply circuit 55. Initially the pre-charging resistor 52 is used. This serves to limit the current. When the DC voltage system is finally charged and its DC voltage corresponds to the rectified AC voltage, the pre-charging resistor 52 present in the active supply circuit 55 is bridged by means of the switch 51.

FIG. 2 shows an embodiment of the inventive design of a DC voltage system which is linked to a three-phase AC voltage network 1 by means of a supply circuit 5. Such an arrangement is possible e.g. within an industrial plant.

The three-phase AC voltage supply 1 is connected to a rectifier circuit via a switch 2 for each phase and a choke 3 for each phase. The rectifier circuit comprises six passive components, particularly diodes, or six controllable semiconductors, particularly IGBTs with antiparallel freewheeling diode 4. A capacitor 6 is connected between the supply circuit 5 and a DC voltage busbar 12. The capacitor 6 is used to smooth the rectified AC voltage. A pre-charging circuit as per FIG. 1 can be provided to pre-charge the capacitor 6.

The DC voltage busbar 12 is connected to the supply circuit 5 via a switching and protection device 8. The switching and protection device 8 comprises an anti-series connection of two controllable semiconductors, preferably IGBTs with anti-parallel freewheeling diode 10, 11, and a switch 9 connected in series with this arrangement.

A DC voltage system is connected to the DC voltage busbar 12. According to the invention, different items of equipment are present in the DC voltage system. A first load 13 is connected to the DC voltage busbar 12 via a first local switching and protection device with pre-charging resistor 7 (local pre-charging device). The switching and protection device with pre-charging resistor 7 is described in FIG. 4 and comprises a pre-charging resistor 73. This pre-charging resistor 73 is connected in parallel with an anti-series connection of two controllable semiconductors, preferably IGBTs with anti-parallel freewheeling diode 71, 72. A switch 74 is located in series with this arrangement or in series with the pre-charging resistor 73.

in particular, a fan, a heater or a lamp can be connected as the first load 13. Connected to the DC voltage busbar 12 via another switching and protection device with pre-charging resistor 7 is a first inverter 14 and a capacitor 15 connected upstream of the first inverter 14. In addition, a sub-system is connected to the busbar 12 by means of a DC voltage busbar 30, wherein this connection can be established via another switching and protection devices with pre-charging device 7. Present in this sub-system are a second and a third load 19 and 20 which are each connected to the sub-system busbar 30 via another switching and protection device with pre-charging resistor 7. Also present in the DC voltage sub-system are a second inverter 22 with upstream capacitor 16 connected via another switching and protection device with pre-charging resistor 7, and a third inverter 17 with upstream capacitor 18 connected via another switching and protection device with pre-charging resistor 7. In particular, motors or robots are connected to the inverters. The DC voltage system also has a capacitive storage device 21 which is connected to the DC voltage busbar 12 via another switching and protection device with pre-charging resistor 7.

An energy source in the form of a photovoltaic system 23 is also available in the DC voltage system. The photovoltaic system 23 is connected to a capacitor 24 via a DC/DC controller 25. This can likewise be connected to the DC voltage busbar 12 via a switching and protection device with pre-charging resistor 7.

Chemical storage devices preferably in the form of batteries are also possible in this DC voltage system. The battery 27 can be connected via a capacitor 26 and a switching and protection device with pre-charging resistor 7 to a DC/DC controller 29 which can in turn be connected to the DC voltage busbar 12 via a capacitor 28 and a switching and protection device with pre-charging resistor 7.

The capacitive storage unit 21, the photovoltaic system 23 and the battery 27 enable a defined DC voltage to be maintained in the DC voltage system and also enable a DC voltage to be increased in the DC voltage system, as already explained. Such devices are therefore indispensable for maintaining the DC voltage in the DC voltage system in the event of a fault when a supplying voltage drops or when the three-phase AC voltage network 1 fails.

In an alternative embodiment (not shown) of the DC voltage system, a local pre-charging device (7) is only connected upstream of loads (13, 19, 20) or rather incorporated therein, but not upstream of the energy storage devices and sources (21, 23, 27).

FIG. 3 shows a method for operating an electrical DC voltage system which is linked by means of a supply circuit to at least one AC voltage network for supplying electrical energy to the DC voltage system, wherein the electrical DC voltage system, which comprises items of equipment which are each connected to a busbar via at least one local pre-charging device, is operated as a function of a voltage value present on the busbar.

The method for operating an electrical DC voltage system is preferably employed when the DC voltage system is in normal mode (explained below) and failure of a supplying AC voltage network occurs.

Normal mode is achieved as follows by connecting the DC voltage system to an AC voltage system: the DC voltage system is connected to a three-phase AC voltage network via a supply circuit and therefore powered up by means of a pre-charging process. All the local pre-charging devices in the DC voltage system are active during this pre-charging process. In the respective local pre-charging device the switch is closed and a control unit turns off at least one IGBT so that a charging current flows via the resistor. As a result, all the capacitors in the DC voltage system are charged. As soon as the difference between a voltage present in the DC voltage system and the voltage on a capacitor in the DC voltage system falls below a defined value, the pre-charging process for said capacitor is terminated and the associated local pre-charging device is deactivated. When all the local pre-charging devices are deactivated, the DC voltage system goes into normal mode.

In method step S1, the DC voltage system is in normal mode. The supply circuit is connected to the AC voltage network, the local pre-charging devices are deactivated. Pre-charging is no longer in operation. As long as the DC voltage in the DC voltage system, also referred to as UDC, is greater than or equal to a minimum value Umin1—denoted by UDC>Umin1 in the figure—the DC voltage system remains in normal mode and therefore in method step S1.

However, when the DC voltage falls below the minimum value Umin1 an event which is triggered in particular by failure of the three-phase AC voltage supply, UDC<Umin1 applies and the supply circuit is disconnected from the AC voltage supply in method step S2.

Controllable energy storage devices and sources, particularly capacitive storage devices, batteries or photovoltaic systems, present in the DC voltage system, are then caused by the control unit to supply electrical energy to the DC voltage system. In addition, less critical loads, particularly fans, present in the electrical DC voltage system are switched off or limited in order to reduce power consumption.

As a result of these measures, it is possible that the DC voltage in the DC voltage system will return above the minimum value Umin1. This is denoted by UDC>Umin1 in the figure.

When the DC voltage does not exceed the minimum value Umin1 and does not fall below a minimum value Umin2—indicated by Umin2<UDC<Umin1—the status remains at method step S2. Method step S2 is also characterized in that the supply circuit is not connected even when the AC voltage supply is restored.

When the DC voltage reduces still further and fails below the minimum value Umin2—denoted by UDC<Umin2—in method step S3 all the local pre-charging devices are activated and all the equipment in the DC voltage system is switched off, The controllable energy storage devices and/or sources are deactivated and no longer supply energy.

When the DC voltage does not exceed the minimum value Umin2 and does not fall below a minimum value Umin3—denoted by Umin3<UDC<Umin2—the status remains at method step S3. Also in method step S3, the supply circuit is not connected when the AC voltage network is restored.

By the local pre-charging devices first being activated and ail the loads only being switched off subsequently, the DC voltage across the equipment decreases further so that a minimum value Umin3 is fallen below.

With the minimum value Umin3 being fallen below, denoted by UDC<Umin3, a state is reached in which all the local pre-charging devices are safely activated.

Then in a method step S4 the supply circuit is connected and restoration of the three-phase AC voltage network is awaited. This state is maintained as long as UDC<Umin1 applies. The controllable energy storage devices and/or sources no longer supply energy.

As an alternative to falling below the minimum value Umin3 as an indicator that all the local pre-charging devices are activated, an activation acknowledgment from the local pre-charging devices can take place or a minimum time tmin since falling below the minimum voltage Umin2 required at the most by the local pre-charging devices for activation can be allowed to elapse. For these alternatives, it is irrelevant whether initially the local pre-charging devices are activated or the equipment is switched off.

When the three-phase AC voltage network is restored and UDC>Umin1 obtains, the pre-charging process recommences in method step S5 as already described above for connection of the DC voltage system. The start of the pre-charging process can be linked to enabling by a control unit.

When the pre-charging process is complete, denoted by Vf in the figure, the DC voltage system is returned to normal mode in method step S1. When the pre-charging process is not complete, denoted by Vnf, the status remains at method step S5.

In an alternative embodiment, in the event of a DC voltage in the DC voltage system falling below a minimum value Umin2—denoted in the figure by UDC<Umin2 in the dashed branch, in method step S31 the DC voltage setpoint for controllable energy storage devices and/or sources present in the DC voltage system is increased to a peak value of the network voltage at an upper tolerance limit. All the loads present in the DC voltage system are switched off.

The energy storage devices and sources increase the DC voltage by supplying electrical energy. As long as UDC<Umin2 applies, the status remains at method step S31.

In this method step 31, the local pre-charging devices continue to be activated and the supply circuit can be connected when the AC voltage network is restored. The pre-charging process for the transition to normal mode can be started.

When the minimum value Umin2 is exceeded—denoted by UDC>Umin2—the local pre-charging devices particularly of critical items of equipment, preferably motors or robots, are deactivated in method step S32 and the critical items of equipment are connected, whereby, as long as UDC>Umin2 applies, the latter move to a defined position or complete at least part of this movement before consumption of electrical energy causes the DC voltage in the DC voltage system to return below the value Umin2—denoted by UDC<Umin2 in the figure.

In addition, in step 32 the supply circuit is not connected when the AC voltage supply is restored. When the defined position is reached and UDC<Umin2 also applies, denoted by UDC<Umin2 & SZ, the DC voltage system goes to S3.

The action from method step S31 is repeated. The energy storage devices and sources increase the DC voltage by again supplying electrical energy so that, when the value Umin2 is exceeded—denoted by UDC>Umin2—in method step S32 robots or motors can execute the remainder of their movement to a defined position. In an embodiment not shown in the figure, when the DC voltage in the DC voltage system exceeds the voltage Umin1 in the states S31 or S32, the supply circuit can be connected on restoration of the AC voltage network. The DC voltage system can transition to the S1 state when pre-charging is complete.

In the method described, it can happen that the DC voltage system remains continuously in S32, as the DC voltage remains between the values Umin1 and Umin2 and the energy storage devices and/or sources exactly cover the energy requirement of the critical loads, particularly motors and robots. In this case it is provided that, when the AC voltage supply is restored, the supply circuit is not connected and non-critical loads are not put into operation. In order to avoid this state, in an embodiment not shown in the figure the energy storage devices and/or sources are deactivated as soon as critical loads have reached their defined position. The voltage in the DC voltage system therefore goes below the value Umin2 and the DC voltage system transitions to S31 where it waits for the AC voltage supply to be restored.

FIG. 4 shows an embodiment of a local switching and protection device with pre-charging resistor 7 (local pre-charging device). This comprises a pre-charging resistor 73. Said pre-charging resistor 73 is connected in parallel with an anti-series connection of two controllable semiconductors, preferably IGBTs with anti-parallel freewheeling diode 71, 72. A switch 74 is connected in series with this arrangement or in series with the pre-charging resistor 73. The switching and protection device with pre-charging device 7 in FIG. 4 is incorporated in the equipment shown in FIG. 2 or connected upstream thereof.

What is claimed is:

1.-23. (canceled)

24. An electrical DC voltage system, comprising:
a plurality of items of equipment,
a busbar switchably connected to a DC side of a supply circuit, with an AC side of the supply circuit connected to an AC voltage network for supplying electrical energy to the DC voltage system,
a local pre-charging device, which is integrated into a respective item of equipment or is connected upstream of the respective item of equipment and which is specifically designed for the respective item equipment, connecting each of the respective items of equipment to the busbar in one-to-one correspondence,
wherein an item of equipment is a single piece of equipment, a combination of a plurality of pieces of equipment or a sub-system.

25. The electrical DC voltage system of claim 24, wherein the local pre-charging device comprises a circuit arrangement composed of a resistor connected in parallel with two semiconductors, and a switch connected in series with the circuit arrangement.

26. The electrical DC voltage system of claim 24, wherein the AC voltage network is designed as a three-phase AC voltage network.

27. The electrical DC voltage system of claims 24, wherein at least one item of equipment in the DC voltage system comprises the local pre-charging device.

28. The electrical DC voltage system of claim 24, wherein the local pre-charging device is connected upstream of at least one item of equipment present in the DC voltage system.

29. The electrical DC voltage system of claim 24, wherein each item of equipment present in the DC voltage system is connected to the busbar via a single local pre-charging device.

30. The electrical DC voltage system of claim 25, wherein the two semiconductors are connected anti-serially.

31. The electrical DC voltage system of claim 25, wherein the two semiconductors are implemented as controllable bipolar transistors, IGBTs, controllable field effect transistors, or MOSFETs.

32. The electrical DC voltage system of claim 24, wherein the local pre-charging device incorporates or is connected to a supervision unit.

33. The electrical DC voltage system of claim 24, wherein the local pre-charging device incorporates or is connected to a control unit.

34. The electrical DC voltage system of claim 33, wherein, below a defined voltage value, the control unit turns off at least one of the two semiconductors to interrupt current flow through the semiconductors and, above the defined voltage value, renders at least one of the two semiconductors conducting to enable current to flow through the semiconductors.

35. The electrical DC voltage system of claim 24, wherein the supply circuit is switchably connected to the AC voltage network.

36. The electrical DC voltage system of claim 24, wherein the supply circuit comprises a rectifier circuit.

37. The electrical DC voltage system of claim 24, wherein the DC voltage system is part of an industrial plant.

38. A method for operating an electrical DC voltage system having a plurality of items of equipment, wherein each of the respective items of equipment is connected to a busbar via a local pre-charging device in one-to-one correspondence, the method comprising:
measuring a voltage value present on the busbar,
when the measured voltage value is greater than a first minimum voltage, operating the electrical DC voltage system in a normal mode, wherein a supply circuit supplying electrical energy to the DC voltage system is connected to an AC voltage network and the local pre-charging device is deactivated, and
when the measured voltage value falls below the first minimum voltage, disconnecting the supply circuit from the AC voltage network.

39. The method of claim 38, further comprising:
when the measured voltage value is less than the first minimum voltage and exceeds a second minimum voltage, supplying electrical energy to the DC voltage system from controllable energy storage devices or energy sources disposed in the DC voltage system.

40. The method of claim 39, further comprising:
when the measured voltage value is less than the first minimum voltage and exceeds the second minimum voltage, switching off loads disposed in the electrical DC voltage system.

41. The method of claim 39, further comprising:
when the measured voltage value falls below the second minimum voltage, activating the local pre-charging devices disposed in the electrical DC voltage system.

42. The method of claim 38, further comprising:
when the measured voltage value is less than a second minimum voltage and greater than a third minimum voltage, deactivating controllable energy storage devices or energy sources disposed in the electrical DC voltage system.

43. The method of claim 38, further comprising:
when the measured voltage value is less than a second minimum voltage and exceeds a third minimum voltage, switching off ail loads disposed in the electrical DC voltage system.

44. The method of claim 38, further comprising:
connecting the supply circuit when the measured voltage value falls below a third minimum voltage or when a minimum time has elapsed since the measured voltage fell below a second minimum voltage or when all local pre-charging devices have transmitted an acknowledgment signal to a higher-order control unit concerning their activation.

45. The method of claim 44, further comprising:
deactivating the local pre-charging devices, when the measured voltage value exceeds the first minimum voltage.

46. The method of claim 38, further comprising:
when the measured voltage value falls below a second minimum voltage, switching off all loads disposed in the electrical DC voltage system, and
switching on at least one particular load, when the measured voltage value exceeds the second minimum voltage after supplying electrical energy from controllable energy storage devices or from energy sources disposed in the electrical DC voltage system.
